(19) United States
(12) Patent Application Publication
(10) Pub. No.: US 2004/0130068 A1
(43) Pub. Date: Jul. 8, 2004

(54) Method of shaping thermoplastic material

(76) Inventor: Urs Fankhauser, Fabrikstrasse (CH)

Correspondence Address: Jacox Meckstroth & Jenkins, 2310 Far Hills Building, Dayton, OH, 45419-1575, US

(21) Appl. No.: 10/471,886

(22) PCT Filed: Mar. 8, 2003
(86) PCT No.: PCT/CH02/00142

(30) Foreign Application Priority Data
Mar. 19, 2001 (EP) 01810274.9

(51) Int. Cl. B29C 43/02

(52) U.S. Cl. 264/320; 425/44

(57) ABSTRACT

A first compression molding tool (1), which forms the female mould (2), has a holder (8). A portion of a raw compound to be pressed is deposited on this holder (8) at a distance from the compression molding tool (1). Before or at the start of the pressing operation, the holder (8) is sunk into the first compression molding tool (1) and releases the portion for the compression molding operation.

### TECHNICAL FIELD

The invention relates to a method of shaping thermoplastic material between two compression molding elements and an apparatus for this purpose.

### PRIOR ART

Compression molding is a means which has been known for long time for producing articles, in particular from a thermoplastic material. For example, closures for foodstuffs packages are produced, in particular plastic closures for beverage bottles.

In order that the preferably thermoplastic material can be processed, the raw granules are extruded and the desired quantity is cut off and is deposited on part of compression molding tool. A second compression molding tool then presses into the first compression molding tool in such a way that the desired product is molded.

In the methods known hitherto, an uncontrolled surface structure often occurs which, in particular, is undesired in terms of material and aesthetics. Above all in the case of closures for foodstuffs containers, the aesthetics are of significant importance in addition to the functional properties.

### SUMMARY OF THE INVENTION

It is an object of the invention to provide a method and an apparatus which permit the production of closures, in particular from an extruded raw plastic compound, without an uncontrolled surface structure occurring on the closures.

The achievement of the object is defined by the features of claim 1. According to the invention, in a method for shaping thermoplastic material between a first and a second compression molding element, a portion of raw compound is deposited on a holder with a small supporting area. The raw compound on the supporting area is at a distance from one compression molding element and is only discharged immediately before, preferably at the start of, the pressing onto the compression molding elements.

The extruded portion of the plastic—also called a pellet—has a temperature of about 180° Celsius. By contrast, the compression molding elements have an operating temperature which is lower by about 120° to 150°. Within the context of the invention, it has now been recognized that the time period between the deposition of the portion and the shaping is critical for the production of undesired surface changes. The surface contact before molding is therefore kept as short as possible, so that “glazing effects” of the surface can be avoided.

When the portion of the extruded plastic compound is deposited on the first compression molding element, in the method according to the invention it does not lie completely on the latter but only on the small supporting area of the holder. The fact that the contact area between the holder and the pellet is kept as small as possible means that excessive cooling, in particular severe partial cooling, of the extruded raw plastic compound before the compression molding operation is not possible. The “cold shock” at the contact area to the holder is so small that the effects present in the prior art are largely avoided. Only immediately before or at the start of pressing does the pellet make contact with the compression molding elements.

The holder preferably supports the pellet only at a point. Depending on the consistency of the pellet, the holder can have one or preferably a plurality of point contact areas. In a preferred embodiment of the method, the holder is sunk, that is to say drawn into the first compression molding element, for the transfer and for the release of the compression molding operation.

In one variant for this purpose, the holder can be arranged on one side wall of one of the compression molding elements. In such an arrangement, the holder is preferably formed in the manner of tongs. Before or during the compression molding operation, the tongs parts open and the pellet falls, preferably positioned accurately on one of the compression molding elements. As soon as the pellet has left the holder, the holder is pulled back completely or pivoted away to the side in such a way that the other compression molding element can penetrate into the one compression molding element.

The holder can also comprise a plurality of parts, which are arranged on the periphery of the compression molding element. If the compression molding element has, for example, a round cross section, three individual rods can be distributed on the periphery at intervals of 120°. In order to hold the pellet, these individual rods are preferably pushed equally far forward toward the centre of the cross section of the molding element, although they do not have to make contact at the centre. Before the compression molding, the rods are preferably pulled back beyond the inner rim of the compression molding element, and the previously deposited pellet falls onto one compression molding element. The second compression molding element can then penetrate unimpeded into the first compression molding element.

It is advantageous in particular if the pellet is centered by the holder. Centering of the pellet is carried out, firstly, by means of approximately accurate deposition of the pellet on the holder and, secondly, by the configuration of the supporting area or supporting points of the holder. In the preferable configuration of the holder with more than two supporting areas, the pellet is centered in a preferred manner on the holder as a result of the force of gravity. The plurality of supporting areas are preferably arranged symmetrically with respect to the centre or with respect to the middle of the compression molding element. In this way, centering the pellet in the compression molding element is made easier. A uniform distribution of the mass generally has an effect on the quality of the production. In the case of asymmetrical compression molding, the centering is redundant unless a quite specific (central or eccentric) position is intended.

Since, in a preferred embodiment of the method, the holder is sunk before or during the compression molding operation, this operation is preferably carried out under control. In particular, a cam-controlled movement of the holder is advantageous for the method, since in this way the movement is carried out continuously. The control can also be carried out by means of a sensor, for example an optical sensor, which allows the holder to move back depending on the position of the second compression molding element.

The apparatus according to the invention comprises a first compression molding element with a holder and a second compression molding element, which penetrates into the first compression molding element in such a way that a pellet—a portion of extruded, thermoplastic material compound—is compression-molded between these two compression molding elements. The holder has a small supporting area for the pellet and supports the latter before it comes into contact with the first compression molding element.

Depending on the consistency of the pellet, the supporting area must be designed accordingly. If the pellet has a consistency which barely permits the pellet to flow, the supporting area can be smaller than if the pellet tends more to flow. Apart from the size, the shape of the supporting area can also be configured in various ways. Apart from a round configuration, a configuration of the supporting area with three, four or more corners is also conceivable. Apart from a point support, a holder with a supporting area of a tube or a bow can also be used. Furthermore, a tongs-like design of the holder is also conceivable, such a holder preferably projecting into the first compression molding element from the side.

The holder can preferably be sunk into the first compression molding element. For this purpose, the first compression molding element has a recess formed in accordance with the configuration of the holder or, if appropriate, even a plurality of such recesses. Since the finished product is not to have any depressions resulting from the holder, the recess in the first compression molding element is configured in such a way that the entire holder can be sunk. It is particularly advantageous if the holder is sunk in the first compression molding element to such an extent that the surface of the holder—the supporting area on which the pellet rests—comes to lie flush with the surface of the base of the first compression molding element.

Referring to the operating sequence, time-controlled movement of the holder is preferred. Control of this type is coordinated with the operating cycle of the entire production apparatus. The holder preferably sinks as soon as the second compression molding element penetrates into the first compression molding element. Known systems are recommended as the control type. If the control of the holder is carried out under cam control, the holder is moved to and fro by a mechanism which runs along a preferably curved rail or along a predetermined cam path. The second compression molding element is preferably also cam-controlled in such a case. Here, the two controllers can also be combined to form one controller. For maintenance reasons, however, two mutually coordinated but mechanically largely independent controllers for the holder and the compression molding elements are preferred.

In addition to the preferred cam control, the holder can, for example, also be pressure-controlled. In this case, a sensor measures the pressure on the holder. As soon as the second compression molding element touches the pellet and therefore the pressure on the holder increases, the latter is pulled back and releases the pellet for the compression molding operation. The control can also be carried out pneumatically or hydraulically.

As has already been mentioned, the configuration of the supporting area of the holder for the pellet depends mainly on the consistency of the pellet. Furthermore, it is preferred if the pellet can be deposited and also centered at the same time. In a preferred embodiment of the holder, the latter has a plurality of pins. In particular, the use of a holder with three pins has been tried and tested. As a result of the approximately accurate deposition and the usual consistency of the pellet, the pellet flows slightly on the three pins and in this way centers itself, which has a positive effect on the compression molding operation and therefore substantially reduces the rejects during production. The cross-section of the pins can be configured as desired. In one preferred embodiment of the holder, the cross-section of the supporting areas is circular.

As a result of configuring the holder with a plurality of pins, the recesses accordingly needed in the first compression molding element can be designed simply. Since, in the case of one holder, three pins in number is preferred, drill holes or, depending on the configuration of the pins, recesses are arranged in the first compression molding element, which are minimally larger than the cross-section of a pin. As a result, any contamination of the necessary recess is minimized and the period of use is substantially prolonged.

As has already been mentioned, the holder preferably moves axially in the first compression molding element. The preferred configuration of the holder has three pins, which are arranged on a baseplate. In order that this holder can be controlled, a plunger is arranged on the baseplate of the holder and is mounted in an axial recess in the first compression molding element. At the end of the first compression molding element against which the pellet is compressed, an axial recess is preferably arranged which is so large that the baseplate of the holder with the pins can be sunk. By means of such a configuration, a dividing layer of the first compression molding element is maintained, through which only the pins of the holder penetrate. Furthermore, the thickness of the dividing layer can be taken into account as well when configuring the recess for the baseplate, since the upper edge of the pins preferably coincides with the compression surface.

As a result of the use of this apparatus, means for the time-controlled movement of the holder are provided. These are preferably cam-controlled or pneumatic means.

The apparatus, and thus the compression molding elements, are designed in particular for shaping plastic closures such as are used for beverage bottles. The first compression molding element is preferably arranged on the bottom, serves as what is known as a female mold and accommodates the holder. The second compression molding element is formed as a punch and penetrates into the first compression molding element.

In order to produce compression-molded products, use is preferably made of what is known as a rotary tower, which has an operating platform that is rotated under control and is equipped with a large number of apparatuses according to the invention. Each of the apparatuses provided has its own controller, these being coordinated with the controllers of the other apparatuses. Therefore, high processing speeds can be achieved with simultaneously high precision. The control of the individual parts, in particular of the holder, the deposition apparatus and the second compression molding elements, is preferably carried out under time control. The control is preferably substantially cam-controlled, which leads to an optimum movement sequence of the production. Cam-controlled is understood to mean a time-controlled movement sequence which is controlled by using a predefined cam. In this case, the individual movement sequences can be controlled with a cam used jointly. Preferably, however, each individual movement sequence is controlled by separate cams which are coordinated with one another.

Further advantageous embodiments and feature combinations of the invention emerge from the following detailed description and all of the patent claims.

### BRIEF DESCRIPTION OF THE DRAWINGS

In the drawings, used to explain the exemplary embodiment:

FIG. 1 shows a schematic, perspective sectional illustration of a compression molding element with the holder according to the invention;

FIGS. 2a-c show the method according to the invention by using schematic sections;

FIG. 3 shows a variant of the holder according to the invention and

FIG. 4 shows a schematic illustration of a holder fixed at the side.

In principle, identical parts are provided with identical designations in the figures.

Ways of Implementing the Invention

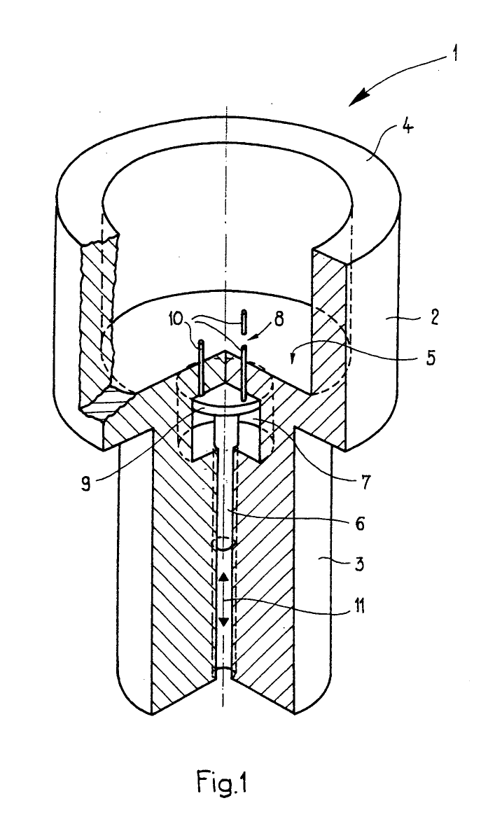

FIG. 1 shows a schematic, perspective sectional illustration of a compression molding element with the holder according to the invention. In this example, first compression molding tool 1 is arranged on the bottom, for which reason the second compression molding tool 14 penetrates into the first compression molding tool 1 from above. The designations above and below refer to the illustration shown. The second compression molding tool 1 could also be arranged on the top, which would necessitate the second compression molding tool 14 penetrating into the first compression molding tool 1 from below.

The first compression molding tool 1 comprises a female mould 2 and a base 3. In one preferred embodiment, the female mould 2 is a hollow cylinder 4 with a base 5. The female mould 2 is the negative mould, which determines the outer configuration of the plastic closure 16. The thickness of the base 5 of the female mould 2 is designed to be approximately the same as the wall thickness of the hollow cylinder 4. The base 3 is preferably connected monolithically to the female mould 2. In this embodiment, the base 3 is formed as a cylinder. The dimensions depend on the product to be produced and the associated loadings. However, these are not of substantial importance for the presentation of the invention.

Arranged in the axial direction in the base 3 is a drilled hole, in which a plunger 6 can be moved to and fro in the vertical direction (see arrow 11). A sliding layer is preferably provided, for example a Teflon coating, in order largely to eliminate the friction of the plunger 6 with the base 3. At the imaginary dividing line between the lower edge of the base 5 and the upper edge of the base 3, a recess 7 is arranged. The size of this recess 7 depends on the configuration of the holder 8. The holder 8 firstly comprises a baseplate 9 and three pins 10 which are fixed to the baseplate 9. The baseplate 9 is connected to the plunger 6 in such a way that to and fro movements of the plunger 6 are completed simultaneously by the plate 9. The base 5 has drilled holes formed in accordance with the thickness and the number of pins 10, in order that the pins 10 can pass through the base 5. The arrangement of pins 10 as a “tripod” is advantageous, depending on the application; the number can range from one to a number of pins needed in accordance with the application. As will be described in more detail below in the description of the method, the holder is pulled back in the vertical direction or downward in this illustration. Since the recess 7 has to accommodate the holder 8 to a large extent, the height of the recess 7 is exactly or somewhat more than the thickness of the baseplate 9 and the length of the pins 10 minus the thickness of the base 5. Further details emerge from the following explanation of part of the individual method steps.

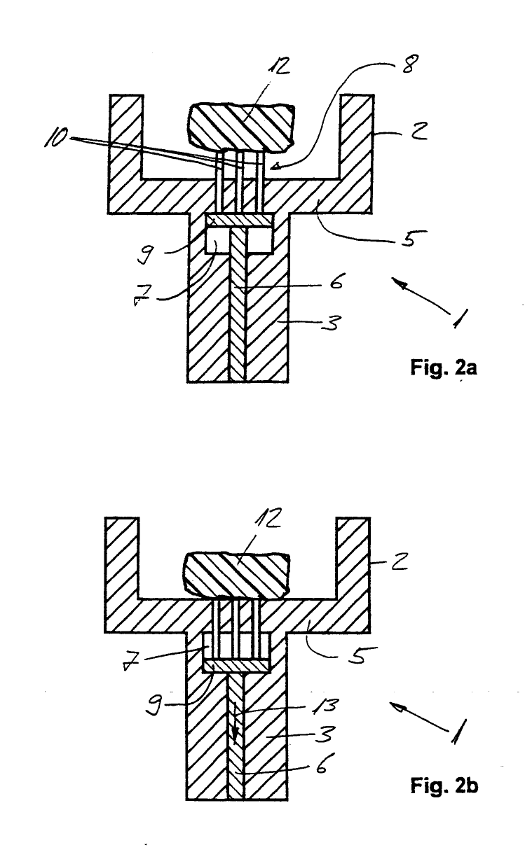

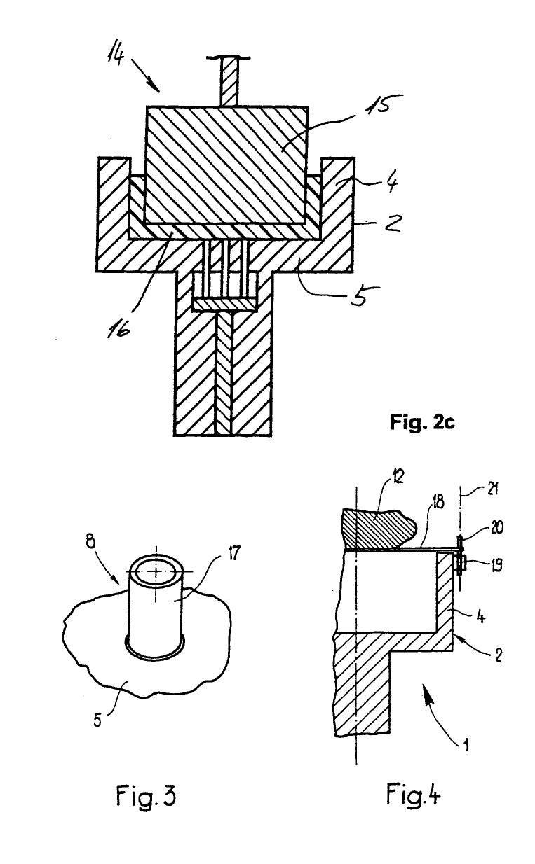

FIGS. 2a-c show individual steps in the method according to the invention using schematic sections.

FIG. 2a shows the initial position of the first compression molding tool 1, in which the holder 8 has been moved up as far as the stop belonging to the baseplate 9. The first compression molding tool 1 is cooled down to about 17° Celsius by a water circuit (not illustrated here). The pins 10 of the holder 8 penetrate the drilled holes in the base 5 and project beyond the latter to such an extent that there is a sufficiently great distance from the supporting points of the holder 8 to the base 5 of the compression molding element 1. As a result, it is ensured that the portion of extruded thermoplastic material deposited on this holder 8, called the pellet 12 below, does not cool down excessively. This is in spite of the fact that there is a large temperature difference—about 160° Celsius in this example—between the pellet 12 and the first compression molding tool 1.

The preparation of the plastic material is carried out by an extrusion apparatus known per se. As soon as a holder 8 is located under an extruder opening, a pellet 12 is cut off on this extruding apparatus, reaching into the operating range of the rotary tower, and is set down, or deposited, on the pins 10 of the holder 8. Each opening of the extrusion apparatus has to be opened and closed under control. The operating procedure from the deposition to the actual compression lasts around two seconds. Since the pellet 12 has only a small contact area with the substantially colder holder 8 and the residence time of the pellet 12 on the latter is relatively short, no severe cooling of the pellet 12 takes place and its temperature, which is around 180° Celsius, is largely maintained until the actual compression molding.

Then, in the preferred embodiment, the plunger 6 is pulled back (see arrow 13) or moved downward in this illustration until the lower edge of the baseplate 9 strikes the base of the recess 7. The state of the holder 8 pulled back completely is shown in FIG. 2b. Since the height of the recess 7 is so large that the upper edge of the pins 10 comes to lie on or under the upper edge of the base 5, the pellet 12 then lies completely on the base 5 of the female mould 2.

Within fractions of a second after the pellet 12 has touched the base 5, the compression molding is carried out, as illustrated in FIG. 2c. The time during which the pellet rests on the base of the tool is therefore preferably only ⅕ or less of the time during which the pellet is within the compression molding tool from deposition until the effective pressing (described below). For this purpose, the second compression molding tool 14, which has been preheated to a temperature of about 50° Celsius by a water circuit (not illustrated here) penetrates into the first, cooled compression molding tool 1. The punch 15 of the second compression molding tool 14 configures the inner shape which, for example, the plastic closure 16 is to have.

The temperature statements relate to an exemplary embodiment of the production. The temperatures, in particular of the compression molding tools 1 and 14, can be adapted depending on the requirements and operating sequence, without this leading to a solution which lies outside the scope of the invention.

The two compression molding tools 1 and 14 remain in the compression molding position for one to two seconds and cool the molded plastic closure 16. The first compression molding tool 1 is then lowered and the second compression molding tool is preferably pulled upward. The plastic closure 16 remains stuck to the punch 15 of the second compression molding tool 14. The plastic closure 16 is stripped off by a sleeve (not illustrated here) which slides downward along the punch 15.

The method described is preferably carried out on a rotary tower (not illustrated here). For this purpose, the rotary tower has a controlled working platform which is provided with a large number of the apparatuses according to the invention. All the movements are carried out under control, cam-controlled movements being preferred. The cam tracks are designed in such a way that, for example, the following movement sequences result:

The holder 8 is in the maximum extended position when holding the pellet 12. As soon as the actual compression molding operation begins, the holder 8 is pulled back in the first compression molding tool 1. As soon as a second compression molding tool 14 is pulled back, the holder 8 is also brought back into its initial position again. Firstly, the path of the movements is determined by the cam track, secondly the holder 8 cannot be moved further than as far as the stop on the lower edge of the base 5 or as far as the lower edge of the recess 7.

The first compression molding tool 1 basically remains in its position. Merely in order to assist the release of the molded plastic closure 16, the first compression molding tool 1 is, for example, lowered slightly at the end of the compression molding operation. The holder 8 is preferably raised at the same time as the first compression molding tool 1 is moved into its initial position again.

The second compression molding tool 14 is lowered as soon as possible after the deposition of the pellet 12. A slight delay can be incorporated if, as a result of inaccurate deposition of the pellet 12, the latter must first be centered on the holder 8. As soon as the second compression molding tool is lowered, the holder 8 is also pulled back. After the compression molding has been completed, the second compression molding tool 14 is pulled back or pulled upward in this illustration, while the finally configured plastic closure 16 is still adhering to the punch 15.

Once the second compression molding tool 14 is in its upper stop position, a sleeve is moved downward, which sweeps along the punch 15 and detaches the plastic closure 16 from the punch 15.

The operations described have to be coordinated with one another. They can last for a complete revolution—360°—of the rotary tower. However, if two extruder openings are arranged opposite each other, for example, then these operations can be restricted to a rotation of 180° of the rotary tower. The requisite rotational angle of the rotary tower for the completion of a complete production operation can be adapted in accordance with these considerations.

A variant of the holder 8 according to the invention is shown in FIG. 3. Instead of the configuration of the holder 8 with a plurality of supporting points, such as with three pins, for example, a tube 17 is provided. As in the case of the solution with a plurality of supporting points, the pellet is deposited on the tube 17 and the latter is pulled back in accordance with the preceding explanations, or sunk in the first compression molding tool. The tubular wall of the tube 17 is preferably formed to be as thin as possible, in order that the contact area between the tube 17 and the pellet is kept as small as possible. The remaining construction of the holder 8 largely corresponds to the explanations given previously.

FIG. 4 shows a schematic illustration of a holder 18 fixed at the side. For this purpose, for example, the first compression molding tool 1 has a holder 19 on the female mould 2 and there preferably on the hollow cylinder 4. The holder 18 is fixed on this holder 19 such that it can rotate, for example with a bolt 20. The holder 18 is preferably formed in two parts in the horizontal plane. In this way, the holder 18 can open in the manner of scissors or tongs and release the pellet 12 in a simple way for the compression molding operation. In order that the holder 18 is not in the way during the compression molding operation, it is rotated away to the side, for example about the axis of rotation 21 which is formed by the bolt 20. After the second compression molding tool has been pulled back, the holder 18 is pivoted back again. The construction can also be modified to the effect that the holder 18, as based on this illustration, is pulled to the right out of the range of action of the second compression molding tool.

It is clear that the exemplary embodiments described can be modified in various aspects. In particular, it should be emphasized that the first compression molding tool can also be arranged with the holder at the top, based on the illustration. For this purpose, however, the pellet must adhere to the holder until the second compression molding tool is in the position in which the pellet cannot fall beside this second compression molding tool.

In this case, the holder can also be constructed in the form of small tongs. For this purpose, for example, the pins can have bent-over portions at their end reaching into the compression molding tool, which hold the pellet for a period of time, similar to a gripping apparatus. During the compression molding operation, the holder is pulled back into the first compression molding tool and releases the pellet when the latter can no longer fall beside the second compression molding tool.

If, in addition, what are known as “glazing” effects occur on the finished product, for example on a plastic closure for beverage bottles, the temperatures, for example of the holder and/or preferably of the compression molding tools, can be adapted. For this purpose, the flow temperatures of the water circuits which heat and, respectively, cool the compression molding tools are adapted. Therefore, the temperature difference between the pellet and the holder or, in particular, the first compression molding tool may be lowered, so that the possibility of a “glazing” effect on the finished product is reduced further.

In a variant of the method described and of the apparatus, the holder can also be designed to act passively. In this case, the holder and therefore the pellet resting on it are forced against the first compression molding tool by the second compression molding tool, it being possible for the holder to be sunk in the first compression molding tool. In order that undesired depressions in the compression-molded product are avoided, the last section of the movement of the holder can be carried out under control, and the holder can be blocked in the sunken position during the actual compression molding. The holder is pulled back into the initial position again after the compression molding operation, for example by a spring mechanism, so that the next pellet can be deposited on said holder.

In summary, it should be noted that, by means of the method according to the invention and the apparatus according to the invention, it is possible in particular to provide plastic closures which have no or only a little uncontrolled surface structure, without the production of such plastic closures being slowed down.

1. A method of shaping thermoplastic material between a first (1) and a second compression molding element (14), a portion (12) of raw compound being deposited on a holder (8) with a low supporting area at a distance from a compression molding element (1) and being discharged onto the compression molding elements (1 or 14) only immediately before or at the start of the pressing, characterized in that the supporting area has at least three point supports (10) which are formed by pins which penetrate a base (5) of the compression molding element (1).

2. The method as claimed in claim 1, characterized in that the holder (8) is sunk into one of the two compression molding elements (1, 14) for the transfer or release.

3. The method as claimed in either of claims 1 and 2, characterized in that the portion (12) is centered by the holder (8).

4. The method as claimed in one of claims 1 to 3, characterized in that the holder (8) is moved under control.

5. An apparatus for ejecting thermoplastic material, comprising a first (1) and a second compression molding element (14), between which a portion (12) of thermoplastic material is pressed, a holder (8) with a small supporting area being provided for the temporary support of the portion (12) before the contact with the compression molding elements (1 and 14), characterized in that the supporting area has at least three point supports (10) which are formed by pins which penetrate a base (5) of the compression molding element (1).

6. The apparatus as claimed in claim 5, characterized in that the holder (8) can be sunk into one of the compression molding elements (1 or 14).

7. The apparatus as claimed in either of claims 5 and 6, characterized in that means for the time-controlled movement of the holder (8) are provided.

8. The apparatus as claimed in one of claims 5 to 7, characterized in that the holder (8) has a plurality of pins (10) for the centered holding of the portion (12).

9. The apparatus as claimed in one of claims 5 to 8, characterized in that the holder (8) is formed by a plunger (6) mounted axially in one of the compression molding elements (1 or 14), and in that the means for the time-controlled movement are of a pneumatic nature.

10. The apparatus as claimed in one of claims 5 to 9, characterized in that the compression molding elements (1 and 14) are designed to shape plastic closures (16), the compression molding element (1) formed as a female mould (2) being arranged at the bottom and accommodating the holder (8).

11. The apparatus as claimed in one of claims 5 to 10, characterized in that it is formed as a rotary tower with a plurality of pressing apparatuses which are each controlled.

12. The apparatus as claimed in claim 11, characterized in that the compression molding elements are cam-controlled.
